(19) United States
(12) Patent Application Publication
(10) Pub. No.: US 2012/0298250 A1
(43) Pub. Date: Nov. 29, 2012

(54) HEAT-SHRINKABLE TUBE, AND PRODUCTION METHOD AND PRODUCTION APPARATUS THEREOF

(75) Inventors: Yasuhiro Fukumoto, Sennan-gun (JP); Hong-Phuc Nguyen, Sennan-gun (JP); Kazuaki Ikeda, Sennan-gun (JP); Masanobu Inoue, Sennan-gun (JP)

(73) Assignee: Sumitomo Electric Fine Polymer, Inc., Sennan-gun (JP)

(21) Appl. No.: 13/576,160

(22) PCT Filed: Dec. 22, 2010
(86) PCT No.: PCT/JP2010/073098

§ 371 Date: Jul. 31, 2012

(30) Foreign Application Priority Data
Feb. 10, 2010 (JP) 2010-027741

(51) Int. Cl. B29C 55/22; B29C 61/08; F16L 9/00

(52) U.S. Cl. 138/177; 264/171.12; 425/149

(57) ABSTRACT

Provided are a method and an apparatus for producing a heat-shrinkable tube. An apparatus 100 includes a pair of pinch rollers 105 that can be moved along a feeding path of a tube 101 and that can be opened and closed with the feeding path therebetween, an air vent 104 that supplies air from an end of the tube 101 to the inside of the tube, a pair of pinch rollers 106 that is arranged closer to the air vent 104 than the pinch rollers 105 and that can be opened and closed with the feeding path therebetween, and a control unit 114 that adjusts inflation of the tube by supplying air in the tube while the pinch rollers 105 are closed and the pinch rollers 106 are opened, then closing the pinch rollers 106, and changing a distance between the pinch rollers 105 and the pinch rollers 106.

### TECHNICAL FIELD

The present invention relates to a heat-shrinkable tube to which heat shrinkability is imparted by inflating a plastic tube, and a production method and production apparatus thereof.

### BACKGROUND ART

Regarding a method for producing a heat-shrinkable tube, PTL 1 describes that an unstretched tube is inflated by applying an inner pressure, and the diameter of the tube is regulated by a stretching pipe. For example, an unstretched tube is fed at a constant rate while compressed gas is supplied from an end of the unstretched tube to the inside of a pipe. The tube is then preheated by hot water, infrared heater, or the like, is put in a stretching pipe that is heated at a stretching temperature and that regulates a stretching ratio in the radial direction, and is subjected to a biaxial stretching. After stretching, the tube is cooled, and is pulled up and taken up as a stretched tube while a stretching pressure is maintained by nipping with a pair of nip rolls.

PTL 2 describes a system for producing a thermoplastic resin film by a tubular method. In this production system, a tubular thermoplastic resin film is stretched at least in a lateral direction by enclosing air in the film. The resin film is introduced in a guide including two guide plates inclined so that the distance therebetween is gradually decreased, pinched with pinch rolls, and pulled up. An angle formed by the guide plates is increased or decreased to increase or decrease a distance from a frost line of a bubble to the guide. Thus, the diameter and the average thickness of the portion of the bubble extending from the frost line to the guide plates are controlled to be constant.

### CITATION LIST

### Patent Literature

PTL 1: Japanese Unexamined Patent Application Publication No. 11-80387
PTL 2: Japanese Unexamined Patent Application Publication No. 10-315322

### SUMMARY OF INVENTION

### Technical Problem

In the methods for producing a heat-shrinkable tube described in PTL 1 and PTL 2, a stretching pipe or guide plates contact the outer circumferential surface of an inflated plastic tube. In the case where a stretching pipe is brought into contact with a plastic tube in order to regulate the diameter of the tube as described in PTL 1, a tube having a small wall thickness adheres to the inner surface of the stretching pipe and is not easily separated from the inner surface. As a result, for example, the tube may be torn, resulting in a decrease in the yield. In the case where a tube is guided with guide plates as described in PTL 2, the tube tends to be rubbed with the guide plates, and scratches are easily formed on the surface of the tube. The scratches cause cracking and splitting of the tube.

In order to solve these problems, the present invention provides a method and an apparatus for producing a heat-shrinkable tube, the method and apparatus being capable of producing a heat-shrinkable tube having a stable quality without bringing a member into contact with the outer circumferential surface of an inflated tube, and the heat-shrinkable tube.

### Solution to Problem

According to an aspect of the present invention, there is provided a method for producing a heat-shrinkable tube including a step of closing a pair of first pinch rollers arranged so as to pinch a plastic tube and a pair of second pinch rollers arranged so as to pinch the tube at a position different from the position of the first pinch rollers to enclose air supplied in the tube between the first pinch rollers and the second pinch rollers; and a step of adjusting inflation of the tube by changing a distance between the first pinch rollers and the second pinch rollers while the first pinch rollers and the second pinch rollers remain closed.

In this production method, in order to enclose air supplied to the inside of the tube between the first pinch rollers and the second pinch rollers, the first pinch rollers and the second pinch rollers are closed, and the distance between the first pinch rollers and the second pinch rollers is changed. When the first pinch rollers and the second pinch rollers are made close to each other, the internal pressure of the tube is increased between the first pinch rollers and the second pinch rollers, and the tube is inflated. Accordingly, by changing the distance between the first pinch rollers and the second pinch rollers, the outer diameter, the wall thickness, and the like of the inflated tube can be adjusted. Therefore, a regulation member such as a stretching pipe is unnecessary in order to regulate the inflated diameter of the tube, and a heat-shrinkable tube having a small wall thickness can also be relatively easily produced. Furthermore, since the tube is fed by the pinch rollers, guide plates or the like are also unnecessary and scratches are not easily formed on the tube through the steps of producing the heat-shrinkable tube. Accordingly, occurrence of cracking and splitting of the tube can also be suppressed.

In the method for producing a heat-shrinkable tube, the step of enclosing air supplied in the tube may include a step of supplying air from an end of the second pinch roller side of the tube in a state where the first pinch rollers are closed and the second pinch rollers are opened, and a step of closing the second pinch rollers while the first pinch rollers remain closed.

The method for producing a heat-shrinkable tube may further include a step of, after the second pinch rollers are closed and before the distance between the first pinch rollers and the second pinch rollers is changed, adjusting the internal pressure of the tube extending from the second pinch rollers on the air supply side to a constant pressure. Accordingly, even in the case where an extruded tube is inflated, it is possible to adjust the outer diameter and the wall thickness before the inflation of the tube in addition to the outer diameter and the wall thickness after the inflation.

The distance between the first pinch rollers and the second pinch rollers may be changed by moving the first pinch rollers. In the case where the position of the second pinch rollers, which are arranged closer to the air supply side than the first pinch rollers, is fixed, even when an extruded tube is inflated, the outer diameter and the wall thickness before the inflation of the tube can be easily stabilized. Consequently, the stability of the subsequent inflation can be further ensured.

The method for producing a heat-shrinkable tube may further include a step of determining an outer diameter of the tube between the first pinch rollers and the second pinch rollers, the tube being continuously fed, wherein the step of adjusting inflation of the tube includes moving the first pinch rollers at a constant initial velocity and then changing the moving velocity of the first pinch rollers on the basis of the determined outer diameter. In the case where the position of the first pinch rollers is temporarily held in a state where a tube that is continuously fed is inflated so as to have a desired outer diameter, and the first pinch rollers are moved only when the outer diameter is changed from the state by various causes, the outer diameter of the inflated tube may become unstable. This is because a rapid change in the internal pressure occurs and the inflation ratio thereby becomes unstable. In the case where a change in the outer diameter is detected while the first pinch rollers are moved at a constant initial velocity, the inflation ratio can be stabilized by increasing or decreasing a moving velocity of the first pinch rollers.

The tube may be heated between the first pinch rollers and the second pinch rollers. In this case, the tube may be heated at a temperature equal to or higher than a glass transition temperature. The tube is easily inflated by heating. The inflated tube may have a thickness (an average thickness) of, for example, 100 μm or less, preferably, 5 μm or more and 50 μm or less, and more preferably, 5 μm or more and 20 μm or less. Even in the case where a tube having such a small wall thickness is produced, the tube can be inflated without causing tearing or the like because a regulation member such as a stretching pipe is not used.

According to another aspect of the present invention, there is provided a heat-shrinkable tube produced by the method described above. This heat-shrinkable tube has substantially no scratch on the surface thereof, and the occurrence of cracking and splitting due to a scratch can also be suppressed during use of the tube.

According to another aspect of the present invention, there is provided an apparatus for producing a heat-shrinkable tube, the apparatus including a pair of first pinch rollers that can be moved along a feeding path of a plastic tube and that can be opened and closed with the feeding path therebetween; an air supply portion that supplies air from an end of the plastic tube into the tube; a pair of second pinch rollers that is arranged closer to the air supply portion than the first pinch rollers and that can be opened and closed with the feeding path therebetween; and a control unit that controls inflation of the tube by supplying air from the air supply portion into the tube in a state where the first pinch rollers are closed and the second pinch rollers are opened, then closing the second pinch rollers, and changing a distance between the first pinch rollers and the second pinch rollers while the first pinch rollers and the second pinch rollers remain closed.

### Advantageous Effects of Invention

According to the present invention, as described above, a heat-shrinkable tube having a stable quality can be obtained without bringing a member into contact with the outer circumferential surface of an inflated tube.

### BRIEF DESCRIPTION OF DRAWINGS

FIG. 1 is a view illustrating the structure of a relevant part of an apparatus for producing a heat-shrinkable tube according to an embodiment of the present invention.

FIG. 2 is a view illustrating a state where only upper pinch rollers are closed in the apparatus for producing a heat-shrinkable tube.

FIG. 3 is a view illustrating a state where the upper pinch rollers and lower pinch rollers are closed in the apparatus for producing a heat-shrinkable tube.

### DESCRIPTION OF EMBODIMENTS

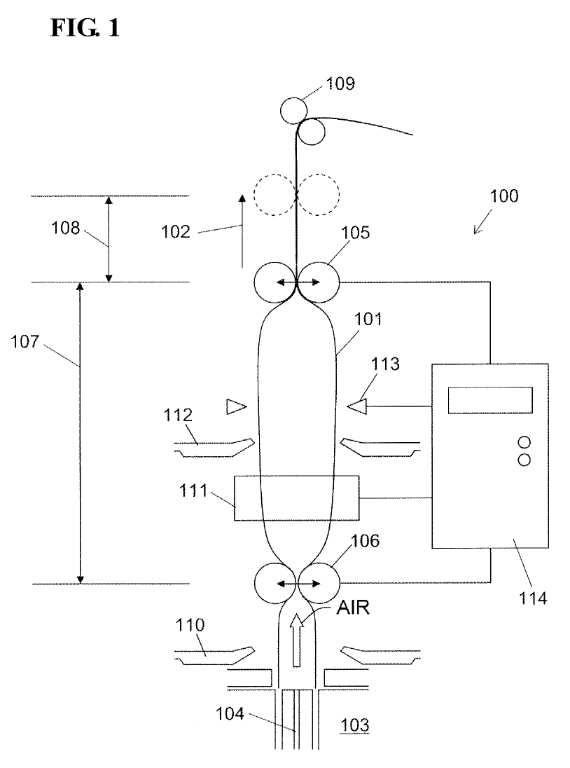

FIG. 1 is a view illustrating the structure of a relevant part of an apparatus for producing a heat-shrinkable tube according to an embodiment of the present invention. A production apparatus 100 according to this embodiment inflates a plastic tube 101 formed by being extruded upward while continuously feeding the plastic tube 101 in the upward direction of a vertical direction 102, thus imparting heat shrinkability to the tube 101. The tube 101 is then taken up. An annular die 103 for extruding a molten resin upward is arranged on the lower side of the production apparatus 100.

The annular die 103 continuously extrudes a molten resin kneaded in an extruder (not illustrated) upward. Thus, the cylindrical plastic tube 101 is formed. Examples of the resin that can be used include, but are not particularly limited to, fluororesins, ionomer resins, polyethylene terephthalate (PET) resins, nylon resins, polyolefin resins such as polyethylene, and various other resins. For example, tetrafluoroethylene-perfluoroalkylvinylether copolymers (PFA) are used as the fluororesins. It is easy to continuously and stably produce a long tube by extrusion molding of PFA. Examples thereof further include various fluororesins such as tetrafluoroethylene-hexafluoropropylene copolymers (FEP), polytetrafluoroethylene (PTFE), ethylene-tetrafluoroethylene copolymers (ETFE), polychlorotrifluoroethylene (PCTFE), ethylene-chlorotrifluoroethylene copolymers (ECTFE), and polyvinylidene fluoride (PVDF). For example, these fluororesins may be used alone or in combination of two or more resins. Furthermore, a plurality of layers may be formed by multiple-extrusion. Electrical conductivity may be imparted to the resin by mixing carbon or the like.

An air vent 104 is provided at the center of the annular die 103. Air is fed to the air vent 104 by a compressor (not illustrated), and the air is supplied from an end of the tube 101 into the tube 101 through the air vent 104. The pressure of the air can be adjusted by a regulator. The tube 101 is inflated by applying an internal pressure to the tube 101 by the air supply. Two pairs of pinch rollers 105 and 106 are used for adjusting the inflation.

The pinch rollers 105 and 106 are arranged above the annular die 103 at positions of different heights. The inflation of the tube 101 is adjusted by changing a distance 107 between the pinch rollers 105 and the pinch rollers 106. In this embodiment, the pinch rollers 105 are arranged so that their positions can be changed in a movable region 108 in the vertical direction 102, and the pinch rollers 106 are arranged so that their positions in the vertical direction 102 are fixed. That is, the distance 107 between the pinch rollers 105 and the pinch rollers 106 is changed by moving the pinch rollers 105. Consequently, the tube 101 is stretched in the radial direction. It is also possible to stretch the tube 101 in an axial direction by adjusting the rotation ratio of the pinch rollers 105 and the pinch rollers 106.

The pair of pinch rollers 105 is arranged so as to pinch a feeding path (pass line) of the tube 101. The pair of pinch rollers 106 is also arranged so as to pinch the feeding path. Each of the pair of the pinch rollers 105 and the pair of the pinch rollers 106 is provided so as to be opened and closed. In the closed state, each of the pairs of the pinch rollers pinches the tube 101. Each of the pairs of the pinch rollers is driven by a motor, and thus the tube 101 can be fed in the upward direction of the vertical direction 102. The tube 101 fed by the pinch rollers is fed to take-up rollers (driving rollers) by guide rollers 109 which are driven rollers, and is taken up by the take-up rollers.

An air ring 110 may be arranged as a cooling mechanism of the resin at the upstream side of the pinch rollers 106 (between the annular die 103 and the pinch rollers 106). The air ring 110 emits cold air to cool the tube 101 extruded from the annular die 103. A heating unit 111, an air ring 112, and sensors 113 are arranged between the pinch rollers 105 and the pinch rollers 106. The heating unit 111 heats the tube 101 to a temperature, for example, equal to or higher than the glass transition temperature of the resin. A far infrared heater or the like can be used as the heating unit 111. The air ring 112 emits cold air to the tube 101 heated by the heating unit 111, and cools the tube 101. In this example, the air ring 112 is arranged between the heating unit 111 and the sensors 113. However, the position of the air ring 112 is not particularly limited as long as the air ring 112 is arranged between the heating unit 111 and the pinch rollers 105. The sensors 113 measure the outer diameter and the film thickness of the tube 101. Transmissive or reflective optical sensors can be used as the sensors 113. The sensors 113 output a detection signal to a control unit 114.

The control unit 114 controls the production apparatus 100 in accordance with an instruction input from an operation panel by a user and the detection signal of the sensors 113 to produce a heat-shrinkable tube. More specifically, the control unit 114 supplies air into the tube 101 through the air vent 104 in a state where the pinch rollers 105 are closed and the pinch rollers 106 are opened, and then closes the pinch rollers 106. The control unit 114 changes the distance between the pinch rollers 105 and the pinch rollers 106 while the pinch rollers 105 and the pinch rollers 106 remain closed, thus adjusting the inflation of the tube.

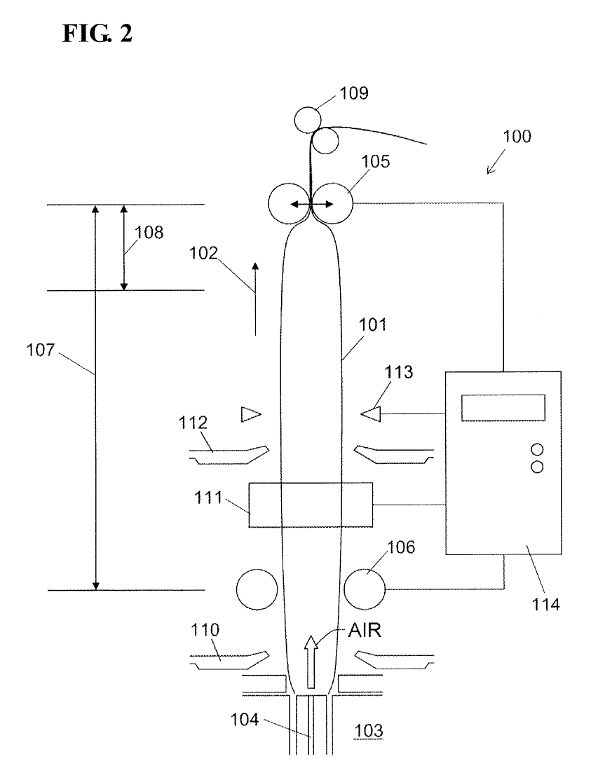

FIG. 2 illustrates a state where only the upper pinch rollers are closed in the apparatus for producing a heat-shrinkable tube. Upon receiving a starting instruction from the operation panel, the control unit 114 sets (the position in the height direction, the opened or closed state, etc. of) the pinch rollers 105 and 106 to an initial state. In this state, the pinch rollers 105 are located at the top of the movable region 108 and closed, and the pinch rollers 106 are opened. The control unit 114 supplies air from the air vent 104 into the tube 101 while continuously feeding the tube 101 in the upward direction of the vertical direction 102 by driving the pinch rollers 105 and 106. The control unit 114 inflates the tube 101 so as to have a desired outer diameter by adjusting the amount of resin discharged and the internal pressure.

The desired outer diameter can be substantially the same as the final outer diameter of the tube 101 (i.e., the final outer diameter of a heat-shrinkable tube). Accordingly, the entire movable region 108 of the pinch rollers 105 can be used for producing a heat-shrinkable tube, and a longer product can be obtained. Therefore, this is advantageous in terms of cost. After the tube 101 is inflated to have a desired outer diameter, the pinch rollers 106 are closed.

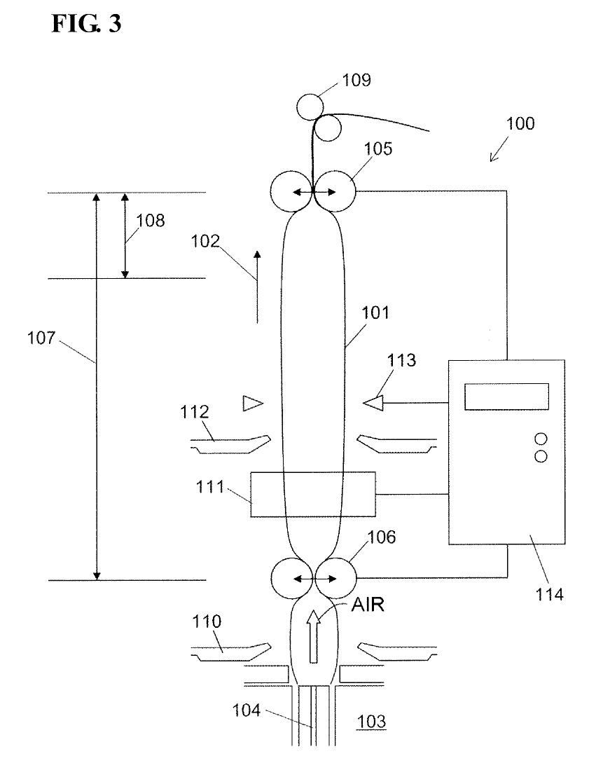

FIG. 3 illustrates a state where the upper pinch rollers and lower pinch rollers are closed in the apparatus for producing a heat-shrinkable tube. The control unit 114 adjusts (reduces) the internal pressure of the tube 101 between the annular die 103 and the pinch rollers 106 to a constant pressure by a regulator in a state where the pinch rollers 106 are also closed, thus obtaining a desired extrusion diameter. The pinch rollers 106, the position of which is fixed in the height direction, are arranged closer to the air vent 104 than the pinch rollers 105, and the extrusion diameter is adjusted while the pinch rollers 106 are closed. Thus, the outer diameter (extrusion diameter) of the extruded tube 101 and the wall thickness of the tube 101 are easily stabilized. As a result, the stability of the subsequent inflation is further ensured. Alternatively, the position of the pinch rollers 105 in the height direction may be fixed and the position of the pinch rollers 106 may be made variable in the height direction. Alternatively, both the position of the pinch rollers 105 and the position of the pinch rollers 106 may be made variable in the height direction. In such a case, the distance from the annular die 103 to the pinch rollers 106 is varied, and thus the internal pressure and the amount of resin discharged are adjusted with a higher accuracy. After a desired extrusion diameter is obtained by adjusting the internal pressure of the tube 101, the control unit 114 moves the pinch rollers 105 downward while the pinch rollers 105 and 106 remain closed.

By closing the pinch rollers 105 and 106, the air supplied in the tube 101 is enclosed between the pinch rollers 105 and the pinch rollers 106. As illustrated in FIG. 1, the pinch rollers 105 moves downward in that state, whereby the internal pressure of the tube 101 is increased between the pinch rollers 105 and the pinch rollers 106 to inflate the tube 101.

In this embodiment, the control unit 114 increases or decreases the moving velocity of the pinch rollers 105 in accordance with the outer diameter determined while allowing the pinch rollers 105 to move at a predetermined initial velocity. The enclosure of air using the pinch rollers is not always perfect. The air may leak from a gap between the rollers, thereby decreasing the internal pressure, and the inflation ratio may be decreased. In the case where the position of the pinch rollers 105 in the height direction is temporarily held and the position of the pinch rollers 105 in the height direction is changed only when the outer diameter changes, a rapid change in the internal pressure occurs and the inflation ratio becomes unstable. For this reason, it is preferable to adjust the moving velocity of the pinch rollers 105 in accordance with the outer diameter determined by the sensors 113 while moving the pinch rollers 105.

The moving velocity of the pinch rollers 105 can be increased or decreased in accordance with, for example, formulae (1) and (2) below, wherein the initial velocity of the pinch rollers 105 is represented by Va [m/min] and a time interval during which a determination result of the outer diameter is fed back is represented by T [sec].

When the time interval T elapses, in the case where the determined outer diameter is smaller than a predetermined lower limit, a velocity Vb after adjustment can be given by the following formula (1):

Vb=Va+A×Va (1)

wherein A represents a velocity-increasing rate [%] that is set in advance with respect to the outer diameter changed by the movement.

When the time interval T elapses, in the case where the determined outer diameter is larger than a predetermined upper limit, a velocity Vb after adjustment can be given by the following formula (2):

Vb=Va−B×Va (2)

wherein B represents a velocity-decreasing rate [%] that is set in advance with respect to the outer diameter changed by the movement.

The adjustment of the moving velocity of the pinch rollers 105 is not limited to the above example. For example, regardless of the initial velocity Va, an increase in the velocity C [m/min] and a decrease in the velocity D [m/min] may be set in advance with respect to the outer diameter changed by the movement. In this method, when the time interval T elapses, in the case where the determined outer diameter is smaller than a predetermined lower limit, a velocity Vb after adjustment can be calculated by the following formula (3). Similarly, in the case where the determined outer diameter is larger than a predetermined upper limit, a velocity Vb after adjustment can be calculated by the following formula (4).

Vb=Va+C (3)

Vb=Va−D (4)

Furthermore, an increase in the velocity or a decrease in the velocity may be fed back on the basis of a predetermined velocity curve (such as a parabola) with respect to the initial velocity Va. This adjustment can be employed because the increase in the internal pressure (the degree of change in the outer diameter) is different between the case where the distance 107 between the pinch rollers 105 and the pinch rollers 106 is decreased by 10 cm when the distance 107 is 100 cm and the case where the distance 107 is decreased by 10 cm when the distance 107 is 20 cm. That is, the adjustment of the velocity is different between the case where the distance between the pinch rollers 105 and the pinch rollers 106 is the largest (at the time of the start of inflation) and the case where the distance between the pinch rollers 105 and the pinch rollers 106 is the smallest.

In the case where there is no change in the outer diameter, the moving velocity may be held at 0 [m/min]. In such a case, when the next change in the outer diameter occurs, the control unit 114 starts the control again using the moving velocity that is set in advance as an initial value. Thus, instability of the inflation ratio can be prevented. In the case where the outer diameter is excessively increased by, for example, decreasing the thickness of the resin (in the case where the strength to the internal pressure is decreased by a decrease in the thickness of the resin, and the inflation ratio is increased), a similar control can also be performed by reversing the movement of the pinch rollers 105.

The interval of the feedback need not be the time interval T, and the interval may be determined in accordance with, for example, the length of the tube produced. In such a case, the control unit 114 controls the increase or decrease in the velocity for every certain length of the tube produced. The elapse of the time interval T can be determined with a timer installed in the control unit 114 or by counting the number of samplings. The certain length of the tube produced can be determined using a rotary encoder or the like.

The control unit 114 adjusts the inflation of the tube 101 between the pinch rollers 105 and the pinch rollers 106 by moving the pinch rollers 105 downward as described above. Consequently, a heat-shrinkable tube having a desired inflated diameter and a desired wall thickness is obtained. This apparatus 100 for producing a heat-shrinkable tube does not need a regulation member, such as a stretching pipe, for regulating the inflated diameter of the tube 101, and can be relatively easily produce a heat-shrinkable tube having a small wall thickness of, for example, 100 μm or less, specifically, 5 μm or more and 50 μm or less, and more specifically, 5 μm or more and 20 μm or less without causing tearing or the like. Furthermore, since the tube is fed by the pinch rollers, guide plates and the like are also unnecessary and scratches are not easily formed on the tube. In the present embodiment, only driving rollers and driven rollers are used for feeding the tube 101. Therefore, scratches are not easily formed on the tube through the steps of producing the heat-shrinkable tube. Accordingly, occurrence of cracking and splitting of the tube can be suppressed.

In the present embodiment, the tube 101 is fed in the upward direction, but the direction is not limited thereto. For example, the tube 101 may be fed in the downward direction. Alternatively, the tube 101 may be fed in the lateral direction (horizontal direction) or any other direction. Furthermore, the extrusion direction and the feed direction may not be the same and may be different from each other. For example, the feed direction may be bent by 90° with respect to the extrusion direction. In the case where a turn-up portion is formed in the pass line of the tube 101 and it is difficult to ensure the internal pressure at the time of the start of the inflation, a step of injecting air in the tube 101 between the pinch rollers 105 and the pinch rollers 106 may be further performed. For example, this injection can be conducted by injecting air from the pinch roller 105 side in the state where the pinch rollers 105 are opened and the pinch rollers 106 are closed, and then closing the pinch rollers 105.

The apparatus 100 for producing a heat-shrinkable tube according to this embodiment does not include a regulation device between the pinch rollers 105 and the pinch rollers 106. However, a regulation device may be additionally provided in order to suppress deflection and vibration of the tube. In such a case, a driven roller or an air ring is preferably used rather than a flat plate or a tubular fixing member. This is for the purpose of suppressing the generation of scratches. The temperature of the roller used for the regulation and the temperature of air emitted from the air ring may be near the inflation temperature or a temperature at which cooling can be performed. These temperatures may be appropriately selected so as to obtain a stable inflation state.

Furthermore, in the embodiment described above, an extruder is directly connected to the apparatus 100 for producing a heat-shrinkable tube, and the extruded tube 101 is continuously fed as it is. This structure is advantageous in terms of the cost because it is possible to omit a step of storing a tube after extrusion. However, a tube produced in another line may be charged in the production apparatus 100.

Furthermore, an electron beam irradiation device may be arranged between the annular die 103 and the pinch rollers 106. By conducting electron beam irradiation to modify a resin, desired characteristics can be imparted, specifically, for example, an effect of shape memory is imparted or a heat-resistant temperature can be improved. Electron beam irradiation is particularly effective for resins which are easily subjected to plastic deformation by inflation, such as polyolefin resins, e.g., polyethylene. The electron beam irradiation device may be installed in the heating unit 111. Furthermore, for resins having low adhesiveness, such as fluororesins, a surface modification such as etching may be conducted on the inner surface or the outer surface of the tube.

The embodiments described above do not limit the technical scope of the present invention, and various modifications and applications can be made within the scope of the present invention. For example, the present invention is also applicable to a case where the inflation of the tube 101 is adjusted by using three or more pairs of pinch rollers.

### INDUSTRIAL APPLICABILITY

The present invention can be widely used in the production of a heat-shrinkable tube for various uses obtained by using a resin such as a fluororesin, an ionomer resin, a PET resin, a nylon resin, a polyolefin resin, or the like and in the supply of the heat-shrinkable tube.

### REFERENCE SIGNS LIST

100 apparatus for producing heat-shrinkable tube
101 plastic tube
102 vertical direction
103 annular die
104 air vent
105, 106 pinch rollers
107 distance between pinch rollers
108 movable region of pinch rollers
109 guide rollers
110, 112 air ring
111 heating unit
113 sensor
114 control unit

1. A method for producing a heat-shrinkable tube, comprising:
a step of closing a pair of first pinch rollers arranged so as to pinch a plastic tube and a pair of second pinch rollers arranged so as to pinch the tube at a position different from the position of the first pinch rollers to enclose air supplied in the tube between the first pinch rollers and the second pinch rollers; and
a step of adjusting inflation of the tube by changing a distance between the first pinch rollers and the second pinch rollers while the first pinch rollers and the second pinch rollers remain closed.

2. The method for producing a heat-shrinkable tube according to claim 1, wherein the step of enclosing air supplied in the tube includes
a step of supplying air from an end of the second pinch roller side of the tube in a state where the first pinch rollers are closed and the second pinch rollers are opened, and
a step of closing the second pinch rollers while the first pinch rollers remain closed.

3. The method for producing a heat-shrinkable tube according to claim 2, further comprising a step of after the second pinch rollers are closed and before the distance between the first pinch rollers and the second pinch rollers is changed, adjusting the internal pressure of the tube extending from the second pinch rollers on the air supply side to a constant pressure.

4. The method for producing a heat-shrinkable tube according to claim 3, wherein the step of adjusting inflation of the tube includes
changing the distance between the first pinch rollers and the second pinch rollers by moving the first pinch rollers.

5. The method for producing a heat-shrinkable tube according to claim 4, further comprising a step of determining an outer diameter of the tube between the first pinch rollers and the second pinch rollers, the tube being continuously fed,
wherein the step of adjusting inflation of the tube includes
moving the first pinch rollers at a constant initial velocity and then changing the moving velocity of the first pinch rollers on the basis of the determined outer diameter.

6. The method for producing a heat-shrinkable tube according to claim 1, wherein the tube is heated between the first pinch rollers and the second pinch rollers.

7. The method for producing a heat-shrinkable tube according to claim 6, wherein the tube is heated at a temperature equal to or higher than a glass transition temperature.

8. The method for producing a heat-shrinkable tube according to claim 1, wherein the inflated tube has a thickness of 100 μm or less.

9. A heat-shrinkable tube produced by the method for producing a heat-shrinkable tube according to claim 1.

10. An apparatus for producing a heat-shrinkable tube, comprising:
a pair of first pinch rollers that can be moved along a feeding path of a plastic tube and that can be opened and closed with the feeding path therebetween;
an air supply portion that supplies air from an end of the plastic tube into the tube;
a pair of second pinch rollers that is arranged closer to the air supply portion than the first pinch rollers and that can be opened and closed with the feeding path therebetween; and
a control unit that adjusts inflation of the tube by supplying air from the air supply portion into the tube in a state where the first pinch rollers are closed and the second pinch rollers are opened, then closing the second pinch rollers, and changing a distance between the first pinch rollers and the second pinch rollers while the first pinch rollers and the second pinch rollers remain closed.
